(19) United States
(12) Patent Application Publication
(10) Pub. No.: US 2019/0186679 A1
(43) Pub. Date: Jun. 20, 2019

(54) SUPPORT

(71) Applicant: Shuwei He, Changsha (CN)

(72) Inventor: Shuwei He, Changsha (CN)

(21) Appl. No.: 16/167,526

(22) Filed: Oct. 22, 2018

(30) Foreign Application Priority Data
Dec. 14, 2017 (CN) 201721742426.X

(51) Int. Cl. F16M 11/04; H04M 1/04; F16B 2/12; H02J 7/02; H02J 7/00

(52) U.S. Cl. CPC F16M 11/046; F16M 11/041; H02J 7/0044; F16B 2/12; H02J 7/025; H04M 1/04

(57) ABSTRACT

The invention provides a support, comprising a telescopic rod; a support front shell; a support back shell, forming an accommodating space with the support front shell; and a clamping mechanism arranged between the two shells, wherein the clamping mechanism comprises a telescopic rod, a left clamping arm and a right clamping arm arranged on both sides of the support, configured to clamp objects from left and right, the two clamping arms are hinged with the support front or back shell; a linkage mechanism for driving the two clamping arms to automatically clamp is formed when the telescopic rod moves downward; and at least one elastic resetting component, arranged in the accommodating space, configured to restore the fixing rod, the left and right clamping arms to initial states thereof. The invention clamps automatically by the gravity of weight, and adjusts the telescopic rod according to the size of equipment.

### BACKGROUND OF THE INVENTION

### 1. Field of the Invention

The invention relates to a support and in particular, to a support used for mobile equipment.

### 2. Description of the Related Art

The size of the prior supports for mobile equipment is substantially fixed, and adjustment on the size is unavailable. There are various sizes of current mobile equipment such as the mobile phone; although most mobile equipment can be clamped, but the prior supports may clip the button set on the side of the mobile phone when clamping due to the difference in size, and cause the misoperation. Moreover, adjustment on the size of some prior supports with wireless charging function is unavailable, so the mobile phone can not be aligned with the transmitting coil, which significantly affects the charging efficiency and is inconvenient for the user.

The prior supports for mobile equipment are often required to be clamped and fixed manually, which is very inconvenient on operation. Although there are also few supports that designed by automatic clamping, for example, by detecting the rotation state of mobile equipment, the electric drive is controlled to achieve automatic clamping, but they have the disadvantages of complex structures, high production costs, and high power consumption. There also exist some supports that use the linkage mechanism to achieve automatic clamping, but the linkage stability and the clamping effect of the prior linkage mechanism are not good enough, and the resetting effect is poor.

### SUMMARY OF THE INVENTION

In view of this, the invention provides a telescopic rod and a support. The invention clamps automatically by the gravity of weight, and adjusts the telescopic rod according to the size of equipment.

A first aspect of the invention provides a telescopic rod, comprising: a fixing rod, wherein a pull trough is arranged on the fixing rod, and a plurality of bulges are arranged at the pull trough; and a movable rod, sheathed on the fixing rod and adjusted up and down relative to the fixing rod, wherein the movable rod comprises: a movable rod front shell; and a movable rod back shell, wherein an elastic clamping piece is arranged on the movable rod front shell or the movable rod back shell, a short shaft is arranged inside the elastic clamping piece and arranged in the pull trough, and a buckle connection capable of adjusting the movable rod up and down is formed by the elastic clamping piece and the bulges at the pull trough.

Further, an operation part for pressing the elastic clamping piece is arranged on the external surface of the movable rod front shell.

A second aspect of the invention provides a support, comprising the telescopic rod, and further comprising: a support front shell; a support back shell, forming an accommodating space with the support front shell; a clamping mechanism, arranged between the support front shell and the support back shell, wherein the clamping mechanism comprises: the telescopic rod; a left clamping arm, arranged on the left side of the support, configured to clamp objects from the left, and hinged with the support front shell or the support back shell; and a right clamping arm, arranged on the right side of the support, configured to clamp objects from the right, and hinged with the support front shell or the support back shell; wherein a linkage mechanism for driving the left clamping arm and the right clamping arm to automatically clamp is formed by the left clamping arm and the right clamping arm when the telescopic rod does a downward movement; and at least one elastic resetting component, arranged in the accommodating space, and configured to restore the fixing rod, the left clamping arm and the right clamping arm to initial states thereof.

Further, a guide post is arranged on the fixing rod, and arranged in a guide chute on the left clamping arm and the right clamping arm respectively.

Further, one end of the elastic resetting component is connected with the left clamping arm or the right clamping arm, and the other end thereof is connected with the support front shell or the support back shell; or two ends of the elastic resetting component are respectively arranged on the left clamping arm and the right clamping arm.

Further, a limiting piece for enabling the fixing rod to keep a downward vertical movement is arranged on the support front shell.

Further, a limiting slot for controlling movement ranges of the left clamping arm and the right clamping arm is formed on the support front shell.

Further, a transmitting coil for charging mobile equipment is arranged in the accommodating space, a winding device driven with a shrapnel is arranged on the transmitting coil, and a data line is wound on the winding device.

Further, a luminous film for self-illuminating at night is arranged on the external surface of the support front shell.

Further, the support further comprises a fixing piece for installing and fixing the support, wherein the fixing piece is connected with the support back shell.

Further, the fixing piece comprises that the fixing piece is a clamping jaw; or the fixing piece comprises a connecting piece fixed on the support back shell and a fixing clamp rotatably connected with the connecting piece, wherein the fixing clamp comprises a clamping body and a connecting rod fixed on the clamping body.

A third aspect of the invention provides a support, comprising: a support front shell; a support back shell, forming an accommodating space with the support front shell; and a clamping mechanism, arranged between the support front shell and the support back shell, and comprising: a left clamping arm, arranged on the left side of the support, configured to clamp objects from the left, and hinged with the support front shell or the support back shell; a right clamping arm, arranged on the right side of the support, configured to clamp objects from the right, and hinged with the support front shell or the support back shell; and a lower pull rod, hinged with the left clamping arm and the right clamping arm respectively, wherein the lower pull rod is configured to hold the clamped objects and pull down in reliance on the gravity of the clamped objects to drive the left clamping arm and the right clamping arm to automatically clamp inwards, and wherein the lower pull rod drives the left clamping arm and the right clamping arm to automatically clamp when doing the downward movement; and at least one elastic resetting component, arranged in the accommodating space, wherein one end of the elastic resetting component is connected with the left clamping arm or the right clamping arm, and the other end thereof is connected with the support front shell or the support back shell, and configured to restore the lower pull rod, the left clamping arm and the right clamping arm to initial states thereof.

Further, a guide post is arranged on the lower pull rod, and arranged in a guide chute on the left clamping arm and the right clamping arm respectively.

Further, a limiting piece for enabling the lower pull rod to keep a downward vertical movement is arranged on the support front shell.

Further, a limiting slot for controlling movement ranges of the left clamping arm and the right clamping arm is formed on the support front shell.

Further, a fixing piece for limiting the clamping mechanism wholly is arranged on the support front shell, and four said fixing pieces are provided.

Further, two clamping ends are arranged at the tail of the lower pull rod, and one clamping end is respectively arranged at the tails of the left clamping arm and the right clamping arm.

Further, a protective cover made of a soft material is sheathed on the clamping end.

Further, a luminous film for self-illuminating at night is arranged on the external surface of the support front shell.

Further, the support further comprises a fixing piece for installing and fixing the support, wherein the fixing piece is connected with the support back shell.

### BRIEF DESCRIPTION OF THE DRAWINGS

FIG. 1 is the exploded view illustrating the telescopic rod of the invention;

FIG. 2 is the stereoscopic view illustrating the structure of the support according to an embodiment of the invention;

FIG. 3 is the stereoscopic view illustrating the structure of the support of the invention after removing the support front shell;

FIG. 4 is the exploded schematic view of the invention;

FIG. 5 is the exploded schematic view illustrating the partial structure of the invention;

FIG. 6 is the schematic view of the invention illustrating the state that the mobile phone is being charged.

### DETAILED DESCRIPTION OF THE PREFERRED EMBODIMENTS

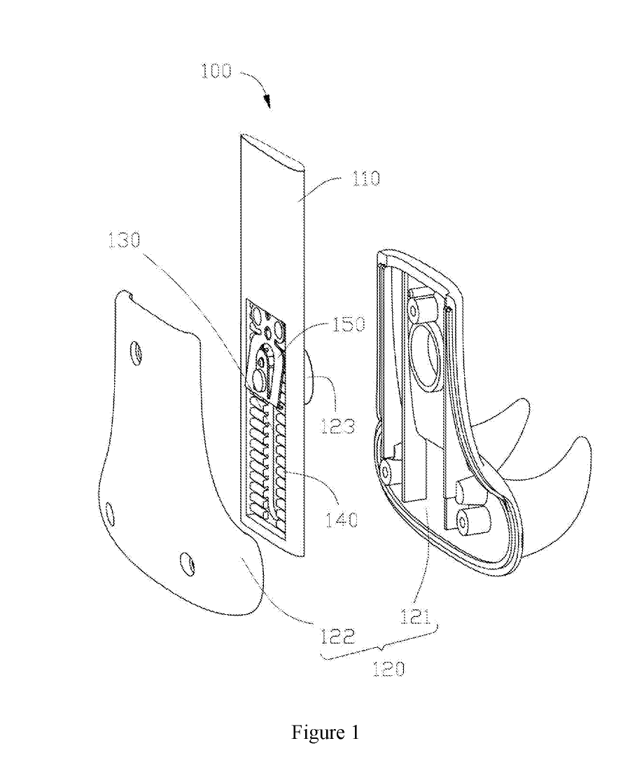

As shown in FIG. 1, the exploded view illustrates the telescopic rod of the invention. The telescopic rod 100 comprises a fixing rod 110 and a movable rod 120 sheathed on the fixing rod 110 and adjusted up and down relative to the fixing rod 110, wherein a pull trough 130 is arranged on the fixing rod 110, and a plurality of bulges 140 are arranged at the pull trough 130. The movable rod 120 comprises: a movable rod front shell 121 and a movable rod back shell 122, wherein an elastic clamping piece 150 is arranged on the movable rod front shell 121 or the movable rod back shell 122; FIG. 1 shows the arrangement of the elastic clamping piece 150 at the movable rod front shell 121, a short shaft is arranged inside the elastic clamping piece 150, the elastic clamping piece 150 is arranged and can move in the pull trough 130, and a buckle connection capable of adjusting the movable rod 120 up and down is formed by the elastic clamping piece 150 and the bulges 140 at the pull trough.

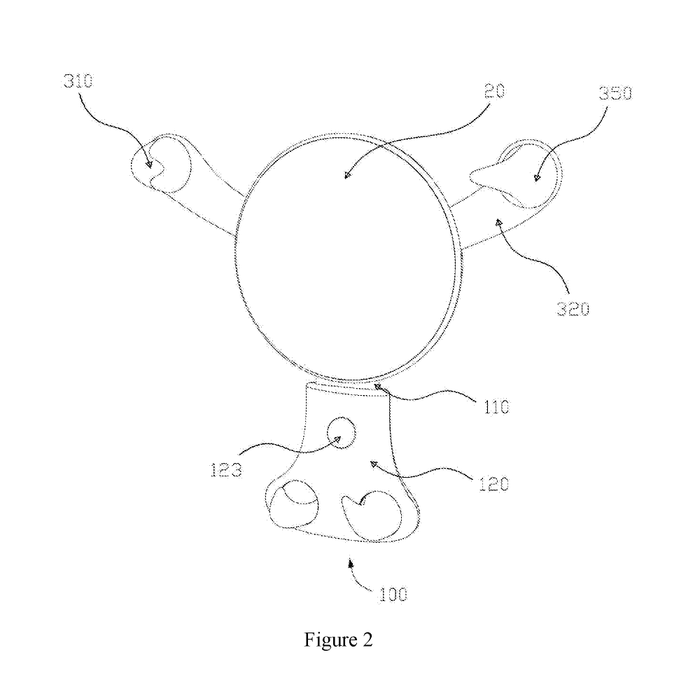

Further, as shown in FIG. 2, an operation part 123 for pressing the elastic clamping piece 150 is arranged on the external surface of the movable rod front shell 121. When the elastic clamping piece 150 is pressed by the operation part 123, the elastic clamping piece 150 can slide in the pull trough 130 without hindrance; when the elastic clamping piece 150 is loosened, the elastic clamping piece 150 contacts and engages with the bulges 140, thereby the movable rod 120 is fixed, and adjustment on the size of the telescopic rod is available.

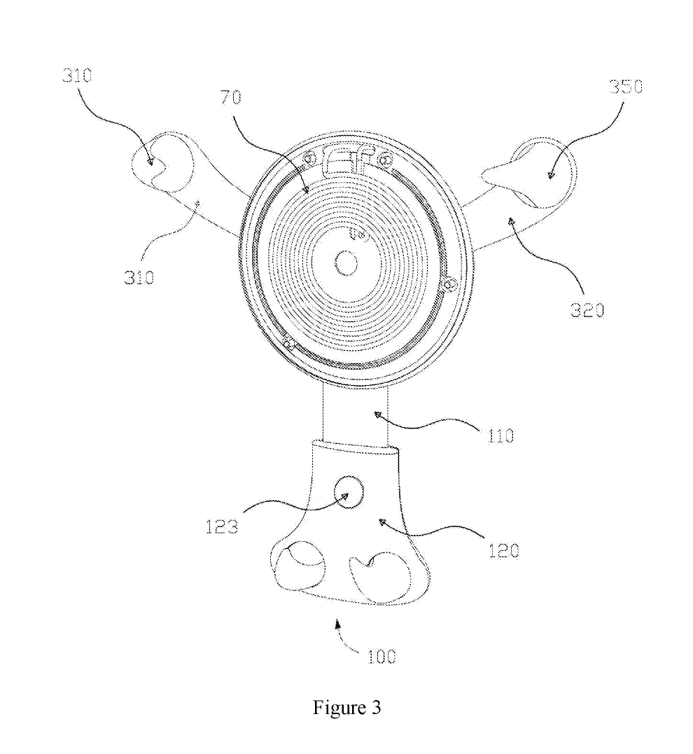

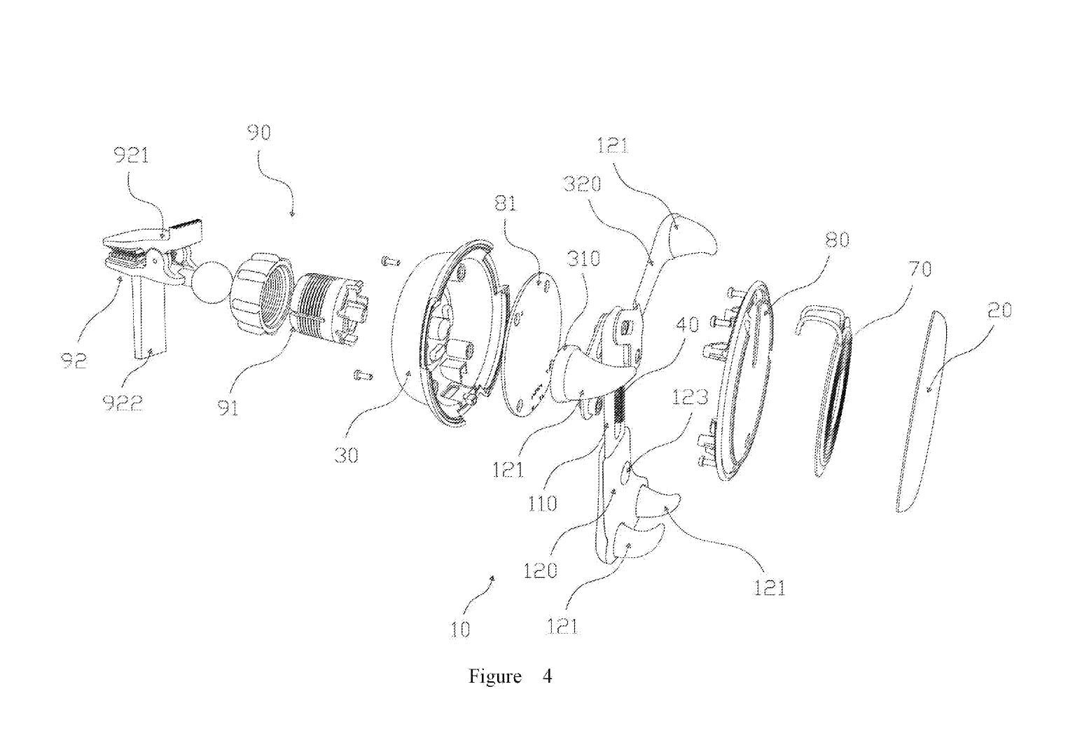

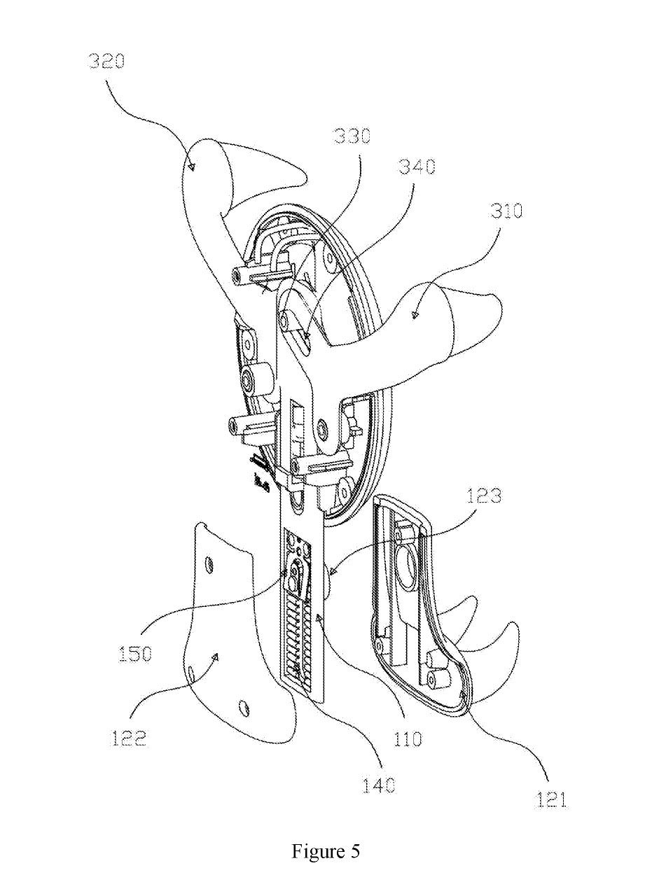

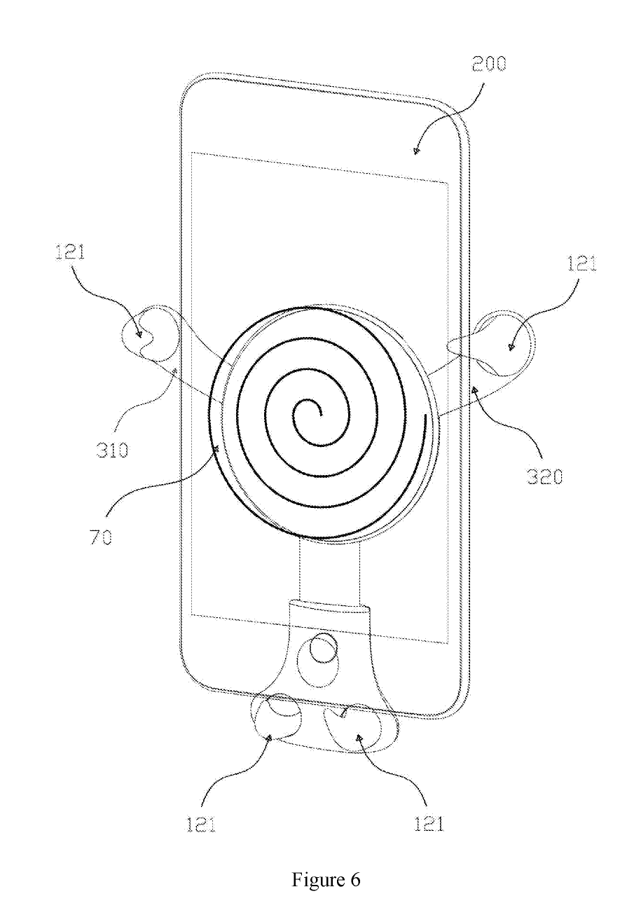

As shown in FIG. 2 to FIG. 5, wherein FIG. 2 is the stereoscopic view illustrating the structure of the support according to an embodiment of the invention; FIG. 3 is the stereoscopic view illustrating the structure of the support of the invention after removing the support front shell; FIG. 4 is the exploded schematic view of the invention; FIG. 5 is the exploded schematic view illustrating the partial structure of the invention; FIG. 6 is the schematic view of the invention illustrating the state that the mobile phone is being charged.

The support further comprises a support front shell 20; a support back shell 30 forming an accommodating space with the support front shell 20; and a clamping mechanism 10 arranged between the support front shell 20 and the support back shell 30; wherein the clamping mechanism comprises a telescopic rod 100, a left clamping arm 310 and a right clamping arm 320 arranged on both sides of the support, configured to clamp objects from left and right respectively; the left clamping arm 310 and the right clamping arm 320 are hinged with the support front shell 20 or the support back shell 30 respectively, a linkage mechanism for driving the left clamping arm 310 and the right clamping arm 320 to automatically clamp is formed when the telescopic rod does a downward movement, and mobile equipment such as the mobile phone 200 are clamped; the telescopic rod, the left clamping arm 310 and the right clamping arm 320 form a “Y” shape.

In particular, when the left clamping arm 310 is hinged with the support front shell 20, the right clamping arm 320 can be hinged with the support front shell 20 or the support back shell 30; when the left clamping arm 310 is hinged with the support back shell 30, the right clamping arm 320 can also be hinged with the support front shell 20 or the support back shell 30.

It can be understood that the telescopic rod may also be replaced by the lower pull rod, replacing the telescopic rod with the lower pull rod; the difference between the telescopic rod and the lower pull rod is that the lower pull rod is the rod with fixed length, while the telescopic rod is the rod that can be telescoped and changed in length.

Further, the support of the invention uses the fixing rod 110 of the telescopic rod or uses the movement of the lower pull rod to drive the left clamping arm 310 and the right clamping arm 320 to move.

In particular, a guide post 330 is arranged on the fixing rod 110 or the lower pull rod, and arranged in a guide chute 340 on the left clamping arm 310 and the right clamping arm 320 respectively, that is, the guide post 330 is matched with the guide chute 340 to form a linkage mechanism; when the fixing rod 110 or the lower pull rod move downward, the guide post 330 moves in the guide chute 340, and drives the left clamping arm 310 and the right clamping arm 320 to rotate and automatically clamp. It can be seen that the structure of the linkage mechanism of the invention is simple, the linkage is more stable, and mobile equipment such as the mobile phone 200 can be clamped better.

In practice, when mobile equipment such as the mobile phone 200 is clamped by the support, the movable rod 120 is adjusted according to the size of the mobile phone 200 to extend the overall length of the telescopic rod, and the button on the side of the mobile phone 200 can be effectively prevented from being clamped, which is convenient for the user.

Furthermore, as shown in FIG. 4, an elastic resetting component 40 is arranged in the accommodating space, configured to restore the fixing rod 110, the left clamping arm 310 and the right clamping arm 320 to initial states thereof. The compression spring in FIG. 4 is used as the elastic resetting component 40; one end of the elastic resetting component 40 is connected with the left clamping arm 310 or the right clamping arm 320, and the other end thereof is connected with the support front shell 20 or the support back shell 30.

In particular, when one end of the elastic resetting component 40 is connected with the left clamping arm 310, the other end thereof can be connected with the support front shell 20 or the support back shell 30; when one end of the elastic resetting component 40 is connected with the right clamping arm, 320 the other end thereof can also be connected with the support front shell 20 or the support back shell 30.

In use, when mobile equipment such as the mobile phone 200 is removed from the support, the elastic resetting component 40 restores the clamping mechanism to the initial state thereof by its own elastic performance for the next use.

In particular use, the user can manually pull down the fixing rod 110, or directly use the weight of mobile equipment such as the mobile phone 200 to move the fixing rod 110 downward, and adjust the movable rod 120 through the operation part 123 to extend the overall length of the telescopic rod, and the linkage mechanism drives the left clamping arm 310 and the right clamping arm 320 to move, so as to clamp mobile equipment such as the mobile phone 200. When there is no demand for continue use, it is only needed to remove the mobile phone 200; the clamping mechanism is automatically restored to the initial state according to the elastic feature of the elastic resetting component 40. The whole process is simple to operate, and the manual clamping by the user is not required, which is convenient for the user.

Preferably, the elastic resetting component 40 can be any one of an extension spring, a torsion spring or other elastic components. And in order to make the structure simpler, the elastic resetting component 40 can be arranged with one or more of them. Two elastic resetting components 40 are preferably arranged in the embodiment. Of course, when the elastic resetting component 40 selects different types of elastic component, the installation and setup of the elastic resetting component 40 are different.

In particular, the elastic resetting component 40 may be connected with the left clamping arm 310 or the right clamping arm 320 at one end, with the other end connected with the support front shell 20 or the support back shell 30, or the two ends are respectively arranged on the left clamping arm 310 and the right clamping arm 320. It should be noted that this embodiment does not limit the type of the elastic resetting component 40, other elastic components capable of achieving the above functions all fall within the scope of the invention.

Further, in order to maintain the vertical movement of the fixing rod 110 and increase the stability of the clamping mechanism, a limiting piece 50 for limiting the fixing rod 110 is arranged on the support front shell of the invention to avoid the left and right swing of the fixing rod while moving downward.

Moreover, a limiting slot 60 for controlling movement ranges of the left clamping arm 310 and the right clamping arm 320 is formed on the support front shell of the invention; the limiting slot 60 is arranged with baffles on both sides, wherein the baffle makes the movement ranges of the left clamping arm 310 and the right clamping arm 320 reasonable, and the support of the invention can be applied to most sizes of mobile equipment.

Of course, another slot can be further arranged in the fixing rod 110 of the invention, and the limiting piece is further arranged on the slot; a block is arranged on the support front shell 20, and the block is formed in the slot of the lower pull rod; when the fixing rod 110 moves downward, the contact between the limiting piece of the slot and the block of the support front shell 20 may also limit movement ranges of the left clamping arm 310 and the right clamping arm 320.

Further, two clamping ends 121 are arranged at the tail of the movable rod 120, and one clamping end 121 is respectively arranged at the tails of the left clamping arm 310 and the right clamping arm 320. The clamping end 121 is used for clamping mobile equipment such as the mobile phone 200, and in order to prevent the mobile phone 200 from being damaged when the clamping end is in contact with mobile equipment such as the mobile phone 200, a protective cover 350 made of a soft material such as the elastic rubber is sheathed on the clamping end in the embodiment, and the protective cover 350 made of a soft material also has the non-slip effect, so that the mobile phone 200 can be better clamped and fixed.

Further, a transmitting coil 70 for charging mobile equipment is arranged in the accommodating space of the invention, a winding device 80 driven with a shrapnel is arranged on the transmitting coil 70, and a data line is wound on the winding device 80; the charging interface is arranged outside the support back shell 30, so that the support of the invention has the wireless charging function. It can be understood that the charging circuit board 81 connected with the transmitting coil 70 may be arranged in the accommodating space.

In particular use, when mobile equipment such as the mobile phone 200 needs to be charged, the mobile phone 200 only needs to be placed on the clamping end of the movable rod 120; the clamping mechanism (the left clamping arm 310 and the right clamping arm 320) moves downward by using the weight of the mobile phone 200, and the length of the movable rod 120 is adjusted by the operation part 123; the linkage mechanism drives the left clamping arm 310 and the right clamping arm 320 to clamp the mobile phone 2000, ensuring that the mobile phone 200 is aligned with the transmitting coil 70, so as to improve the charging efficiency of the mobile phone 200. When the support needs to be charged, the data line can be pulled out simply by pulling the charging interface outside, when the data line needs to be withdrawn, the data line is automatically withdrawn to the winding device 80 by the spring-back function of the shrapnel.

The support further comprises the fixing piece 90 for installing and fixing the support, and the support can be fixed on other components through the fixing piece 90. Preferably, the fixing piece 90 an be a clamping jaw or, the fixing piece 90 comprises a connecting piece 91 fixed on the support back shell 30 and a fixing clamp 92 rotatably connected with the connecting piece 91, wherein the fixing clamp 92 comprises a clamping body 921 and a connecting rod 922 fixed on the clamping body 921. For example, the support of the invention is installed on the air outlet of the automobile by the clamping jaw, and the mobile phone 200 can be placed and fixed during driving.

A luminous film is arranged on the external surface of the support front shell 20 of the invention, so that the support front shell 20 emits fluorescence at night to prompt the specific position of the support, which is convenient on operation to the user; the problem can be avoided that it is difficult for the user to determine the specific position of the support and thus, it takes a long time to place the mobile phone 200 due to the dark light at night, which not only brings inconvenience to the user, but also increases the risk of driving safety.

1. A telescopic rod, comprising:
a fixing rod, wherein a pull trough is arranged on the fixing rod, and a plurality of bulges are arranged at the pull trough; and
a movable rod, sheathed on the fixing rod and adjusted up and down relative to the fixing rod, wherein the movable rod comprises:
a movable rod front shell; and
a movable rod back shell, wherein an elastic clamping piece is arranged on the movable rod front shell or the movable rod back shell, a short shaft is arranged inside the elastic clamping piece and arranged in the pull trough, and a buckle connection capable of adjusting the movable rod up and down is formed by the elastic clamping piece and the bulges at the pull trough.

2. The telescopic rod of claim 1, wherein an operation part for pressing the elastic clamping piece is arranged on the external surface of the movable rod front shell.

3. A support, comprising:
a telescopic rod;
a support front shell;
a support back shell, forming an accommodating space with the support front shell;
a clamping mechanism, arranged between the support front shell and the support back shell, wherein the clamping mechanism comprises:
the telescopic rod;
a left clamping arm, arranged on the left side of the support, configured to clamp objects from the left, and hinged with the support front shell or the support back shell; and
a right clamping arm, arranged on the right side of the support, configured to clamp objects from the right, and hinged with the support front shell or the support back shell;
wherein a linkage mechanism for driving the left clamping arm and the right clamping arm to automatically clamp is formed by the left clamping arm and the right clamping arm when the telescopic rod does a downward movement; and
at least one elastic resetting component, arranged in the accommodating space, and configured to restore the fixing rod, the left clamping arm and the right clamping arm to initial states thereof.

4. The support of claim 3, wherein a guide post is arranged on the fixing rod, and arranged in a guide chute on the left clamping arm and the right clamping arm respectively.

5. The support of claim 3, wherein one end of the elastic resetting component is connected with the left clamping arm or the right clamping arm, and the other end thereof is connected with the support front shell or the support back shell; or
two ends of the elastic resetting component are respectively arranged on the left clamping arm and the right clamping arm.

6. The support of claim 3, wherein a limiting piece for enabling the fixing rod to keep a downward vertical movement is arranged on the support front shell.

7. The support of claim 3, wherein a limiting slot for controlling movement ranges of the left clamping arm and the right clamping arm is formed on the support front shell.

8. The support of claim 3, wherein a transmitting coil for charging mobile equipment is arranged in the accommodating space, a winding device driven with a shrapnel is arranged on the transmitting coil, and a data line is wound on the winding device.

9. The support according to claim 3, wherein a luminous film for self-illuminating at night is arranged on the external surface of the support front shell.

10. The support of claim 3, further comprising a fixing piece for installing and fixing the support, wherein the fixing piece is connected with the support back shell.

11. The support of claim 10, wherein the fixing piece comprises that the fixing piece is a clamping jaw; or
the fixing piece comprises a connecting piece fixed on the support back shell and a fixing clamp rotatably connected with the connecting piece, wherein the fixing clamp comprises a clamping body and a connecting rod fixed on the clamping body.

12. A support, comprising:
a support front shell;
a support back shell, forming an accommodating space with the support front shell; and
a clamping mechanism, arranged between the support front shell and the support back shell, and comprising:
a left clamping arm, arranged on the left side of the support, configured to clamp objects from the left, and hinged with the support front shell or the support back shell;
a right clamping arm, arranged on the right side of the support, configured to clamp objects from the right, and hinged with the support front shell or the support back shell; and
a lower pull rod, hinged with the left clamping arm and the right clamping arm respectively, wherein the lower pull rod is configured to hold the clamped objects and pull down in reliance on the gravity of the clamped objects to drive the left clamping arm and the right clamping arm to automatically clamp inwards, and wherein the lower pull rod drives the left clamping arm and the right clamping arm to automatically clamp when doing the downward movement; and
at least one elastic resetting component, arranged in the accommodating space, wherein one end of the elastic resetting component is connected with the left clamping arm or the right clamping arm, and the other end thereof is connected with the support front shell or the support back shell, and configured to restore the lower pull rod, the left clamping arm and the right clamping arm to initial states thereof.

13. The support of claim 12, wherein a guide post is arranged on the lower pull rod, and arranged in a guide chute on the left clamping arm and the right clamping arm respectively.

14. The support of claim 12, wherein a limiting piece for enabling the lower pull rod to keep a downward vertical movement is arranged on the support front shell.

15. The support of claim 12, wherein a limiting slot for controlling movement ranges of the left clamping arm and the right clamping arm is formed on the support front shell.

16. The support of claim 12, wherein a fixing piece for limiting the clamping mechanism wholly is arranged on the support front shell, and four said fixing pieces are provided.

17. The support of claim 12, wherein two clamping ends are arranged at the tail of the lower pull rod, and one clamping end is respectively arranged at the tails of the left clamping arm and the right clamping arm.

18. The support of claim 17, wherein a protective cover made of a soft material is sheathed on the clamping end.

19. The support of claim 12, wherein a luminous film for self-illuminating at night is arranged on the external surface of the support front shell.

20. The support of claim 12, further comprising a fixing piece for installing and fixing the support, wherein the fixing piece is connected with the support back shell.
